(19) United States
(12) Patent Application Publication
(10) Pub. No.: US 2008/0291568 A1
(43) Pub. Date: Nov. 27, 2008

(54) MAGNETIC DISK APPARATUS AND METHOD FOR CONTROLLING MAGNETIC HEAD

(75) Inventors: Shinji Takakura, Kanagawa-ken (JP); Kohei Maruchi, Tokyo (JP); Mitsunobu Yoshida, Kanagawa-ken (JP)

Correspondence Address: AMIN, TUROCY & CALVIN, LLP, 1900 EAST 9TH STREET, NATIONAL CITY CENTER, 24TH FLOOR,, CLEVELAND, OH, 44114, US

(73) Assignee: KABUSHIKI KAISHA TOSHIBA, Tokyo (JP)

(21) Appl. No.: 12/025,305

(22) Filed: Feb. 4, 2008

(30) Foreign Application Priority Data
Mar. 27, 2007 (JP) 2007-081901

(51) Int. Cl. G11B 5/596

(52) U.S. Cl. 360/78.06

(57) ABSTRACT

A magnetic disk apparatus includes: a driving unit; a position error feedback control system; and a velocity control system. The driving unit is configured to move a magnetic head operative for magnetic recording/reproduction of information on a magnetic disk. The position error feedback control system is configured to perform feedback control of the driving unit based on difference between target track position and detected position of the magnetic head. The velocity control system is configured to vary a target velocity curve based on position of the magnetic head before motion, the target track position of the magnetic head, and position of a data sector to be subjected to recording/reproduction, for using a control mathematical model of the driving unit to control the driving unit so that velocity of the driving unit follows the target velocity curve.

### CROSS-REFERENCE TO RELATED APPLICATIONS

This application is based upon and claims the benefit of priority from the prior Japanese Patent Application No. 2007-081901, filed on Mar. 27, 2007; the entire contents of which are incorporated herein by reference.

### BACKGROUND OF THE INVENTION

1. Field of the Invention

This invention relates to a magnetic disk apparatus and a method for controlling a magnetic head in which a magnetic head is moved above a rotating magnetic disk.

2. Background Art

The positioning control system for a magnetic head of a magnetic disk apparatus typically includes a digital control system based on a microcomputer. More specifically, on the basis of discretely obtained position information of the head, a control command is calculated in a microprocessor and is presented to the driving unit of an actuator through a D/A (digital/analog) converter. In general, an actuator has mechanical resonance in high-frequency bands. Hence, in order to move a magnetic head to a target position with high velocity, low vibration, and low noise, it is very important to generate a feedforward control input that avoids excitation of mechanical resonance.

As a method for rapidly moving a magnetic head by a short distance, feedforward control inputs to the actuator that avoid excitation of mechanical resonance and target position commands to the feedback control system may be calculated beforehand using optimization techniques and retained as a table. However, using such a method for every seek distance is impossible in light of the memory capacity of a microprocessor. Thus, in the case of a long-distance seek, the feedforward control input to the actuator and the target position command must be generated on-line.

As a method for this purpose, an actuator model may be provided in the control system, and the model velocity can be caused to follow a target velocity curve. Thus a control command to the model and a model position can be presented to the feedback control system as a feedforward control input to the actuator and a target position command, respectively. However, it is difficult to use optimization techniques because of online generation of data, and to realize rapid seek that avoids excitation of mechanical resonance.

On the other hand, in a magnetic disk apparatus, data read/write can be performed only after a desired data sector comes under the head. More specifically, when the desired data sector is located away at seek start time, it is wasteful to move the head at a high speed that may result in exciting mechanical resonance of the actuator, because it is then necessary to wait for the data sector to be written to come under the head after reaching the target track. In this regard, JP-A 2000-040317 (Kokai) discloses a method for varying the maximum of the target velocity of the head depending on the position of the data sector to be written at seek start time.

### SUMMARY OF THE INVENTION

According to an aspect of the invention, there is provided a magnetic disk apparatus including: a driving unit configured to move a magnetic head operative for magnetic recording/reproduction of information on a magnetic disk; a position error feedback control system configured to perform feedback control of the driving unit based on difference between target track position and detected position of the magnetic head; and a velocity control system configured to vary a target velocity curve based on position of the magnetic head before motion, the target track position of the magnetic head, and position of a data sector to be subjected to recording/reproduction, for using a control mathematical model of the driving unit to control the driving unit so that velocity of the driving unit follows the target velocity curve.

According to another aspect of the invention, there is provided a magnetic disk apparatus including: a driving unit configured to move a magnetic head operative for magnetic recording/reproduction of information on a magnetic disk; and a velocity control system configured to control the driving unit, the velocity control system varying a target velocity curve based on a time until a data sector comes under a target track position of the magnetic head, the time being found from a position of the magnetic head before motion, the target track position of the magnetic head, and a position of a data sector to be subjected to recording/reproduction.

According to another aspect of the invention, there is provided a method for controlling a magnetic head of a magnetic disk apparatus including: performing feedback control of a driving unit based on difference between target track position and detected position of the magnetic head; and, concurrently, varying a target velocity curve based on position of the magnetic head before motion, the target track position of the magnetic head, and position of a data sector to be subjected to recording/reproduction, and controlling the driving unit by using a control mathematical model of the driving unit so that a velocity of the driving unit follows the target velocity curve.

### BRIEF DESCRIPTION OF THE DRAWINGS

FIG. 1 is a conceptual view showing the main part of a magnetic disk apparatus according to the embodiment of the invention.

FIG. 2 is a schematic view showing a seek control system of the magnetic disk apparatus of this embodiment.

FIG. 3 is a conceptual view showing the process performed in a seek control system.

FIG. 4 is a conceptual view showing the process performed in a seek control system of a magnetic disk apparatus of a comparative example.

FIGS. 5A and 5B are schematic views illustrating the relationship between the magnetic head and the disk.

FIG. 6 is a block diagram illustrating a seek control system of the magnetic disk apparatus of this embodiment.

FIGS. 7A and 7B are block diagrams illustrating a seek control system of a magnetic disk apparatus of a comparative example.

FIG. 8 conceptually illustrates a table of the parameter set stored in the target velocity curve determination unit 310 and the velocity feedback gain determination unit 320.

FIG. 9 is a graph illustrating the temporal variation of the target velocity.

FIGS. 10A and 10B show graphs of the frequency characteristics of a controlled object in this example.

FIGS. 11A and 11B show graphs of control commands to the VCM.

FIGS. 12A and 12B show graphs of response waveforms at the settling time of the VCM.

### DETAILED DESCRIPTION OF THE INVENTION

An embodiment of the invention will now be described in detail with reference to the drawings.

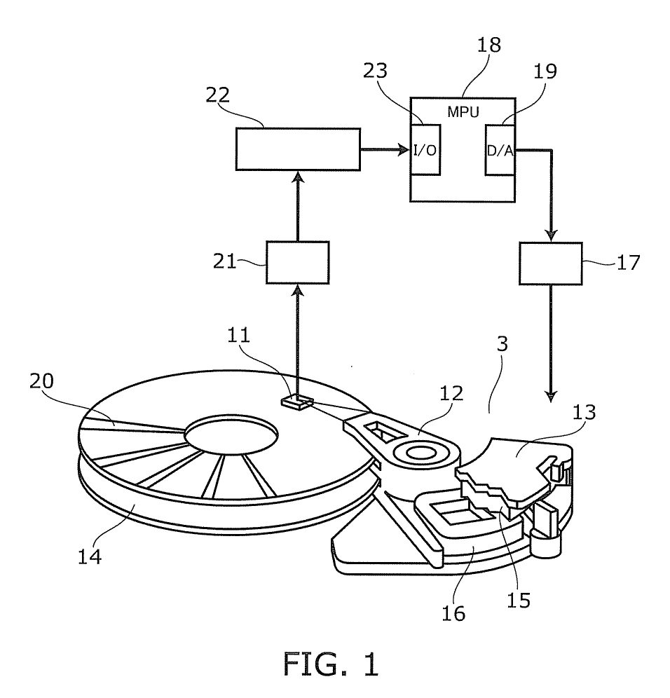

FIG. 1 is a conceptual view showing the main part of a magnetic disk apparatus according to the embodiment of the invention.

The magnetic disk apparatus of this embodiment comprises a head positioning control mechanism primarily composed of a microprocessor (MPU) 18. A magnetic head 11 is supported by an arm 12. The arm 12 moves the magnetic head 11 in the radial direction of a disk 14 by the driving force of a voice coil motor (VCM) 13 provided in a driving unit 3. The VCM 13 includes a magnet 15 and a driving coil 16, and is driven by a current supplied from a power amplifier 17. The MPU 18 computes a control command, which is converted to an analog signal by a D/A converter 19 and presented to the power amplifier 17. The power amplifier 17 converts the control command from the MPU 18 to a driving current and supplies it to the VCM 13.

The apparatus includes one or more disks 14, which are rapidly rotated by a spindle motor. A plurality of tracks are formed concentrically on the disk 14 with uniformly spaced servo areas 20. Track position information is embedded beforehand in the servo area 20. By the traverse of the magnetic head 11 on the servo area 20, a signal from the magnetic head 11 is retrieved by a head amplifier 21, which amplifies this read signal and supplies the signal to a servo data processing circuit 22. The servo data processing circuit 22 generates servo information from the amplified read signal and outputs it to the MPU 18 at regular time intervals. The MPU calculates the position of the magnetic head 11 from the servo information retrieved from an I/O 23 and computes, at regular time intervals from the resulting head position, a control command to be sent to the VCM 13.

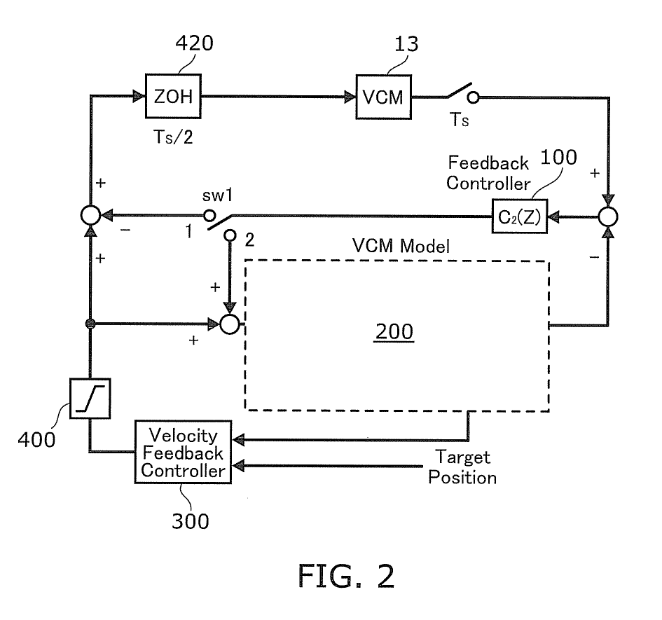

FIG. 2 is a schematic view showing a seek control system of the magnetic disk apparatus of this embodiment.

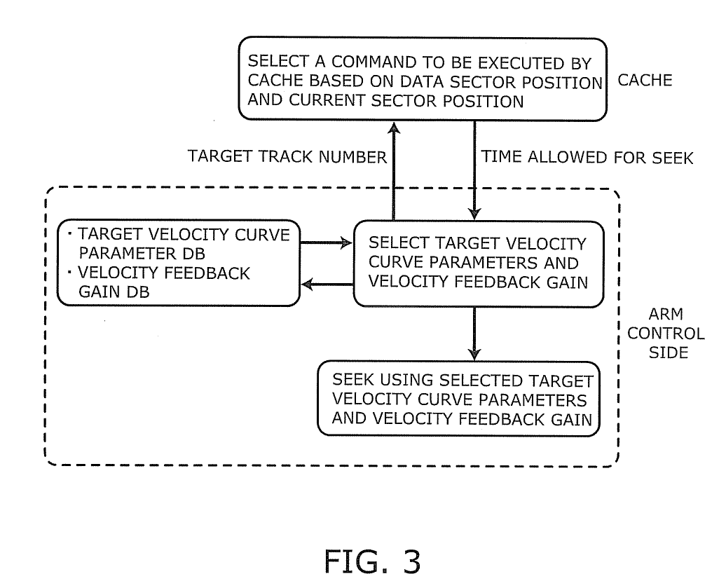

FIG. 3 is a conceptual view showing the process performed in this seek control system.

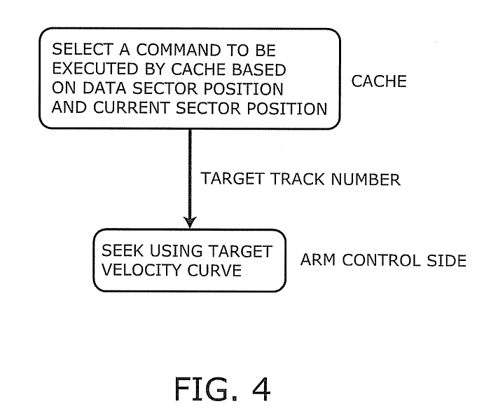

FIG. 4 is a conceptual view showing the process performed in a seek control system of a magnetic disk apparatus of a comparative example.

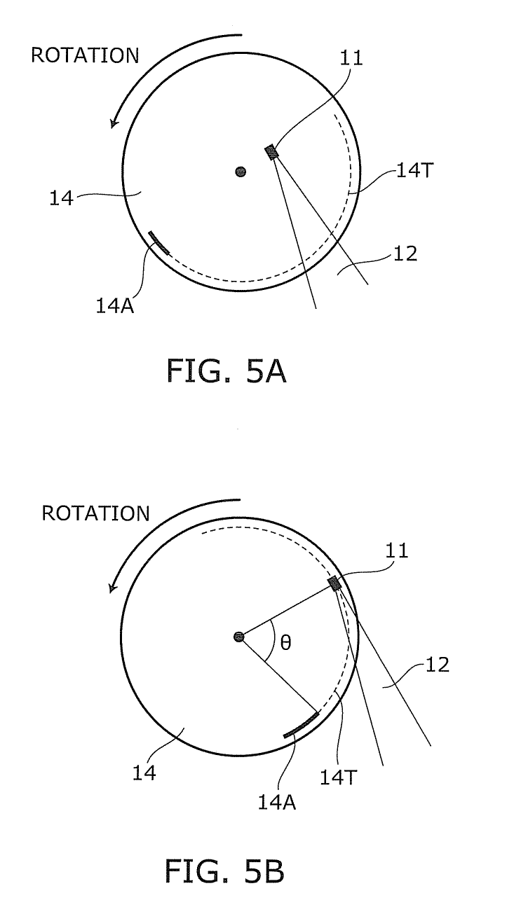

FIGS. 5A and 5B are schematic views illustrating the relationship between the magnetic head and the disk.

The seek control system shown in FIG. 2 comprises a position error feedback control system (C₂(z)) 100, a model control system 200 and a velocity feedback controller 300. The model control system 200 and the velocity feedback controller 300 form a velocity control system. In the model control system 200, a virtual mathematical model of the actuator is established. A target position command to be presented to the position error feedback control system 100 and a feedforward control input are generated by causing the model velocity to follow a target velocity. The feedforward control input outputted from the model control system 200 is inputted to a velocity feedback controller 300 along with information on a target track position (target position), and outputted through a limiter 400 as a feedforward control input to the voice coil motor 13.

For improving the seek performance of the actuator (VCM 13), it is important to provide a smooth feedforward control input to the actuator. To this end, computation in the model control system 200 is performed at a sampling frequency n times that in the feedback control system 100.

During the seek time, the position error feedback control system 100 is operable in the “observer mode” and “two-degree-of-freedom control mode”. In the observer mode during the first half of the seek, the output of the feedback control system 100 is applied to the input end of the model control system 200 (switch sw1 is connected to terminal 2) to make the state (position and velocity) of the model close to the motion of the actuator. During the second half of the seek, the output of the feedback control system 100 is applied to the actuator (VCM 13) (switch sw1 is connected to terminal 1) for operation as a normal two-degree-of-freedom control system. Thus the effect of current saturation and the effect of position detection noise during the seek time can be reduced.

In such a seek control system, a target velocity curve and a velocity control system may be configured so that, given only the position of a target track (target track number), the head is moved to the target track as soon as possible, as in the comparative example shown in FIG. 4. Alternatively, as disclosed in JP-A 2000-040317 (Kokai), only the maximum of the target velocity may be varied on the basis of the position of the data sector to be written.

However, if the same target velocity curve and velocity control system parameters are constantly used, that is, if the variation of acceleration/deceleration is constant, mechanical resonance of the arm may be excited. For example, as shown in FIG. 5A, the data sector to be written 14A may be located away from the magnetic head 11. That is, there is enough time until the data sector 14A comes under the magnetic head 11. In such a case, if the magnetic head 11 is sought at maximum velocity, as shown in FIG. 5B, the data sector to be written 14A has not yet come under the magnetic head 11 when the magnetic head 11 reaches the target track 14T, and hence a latency time occurs. However, rapidly seeking and decelerating a magnetic head tends to excite mechanical resonance of the arm 12. Hence, when the data sector 14A comes under the magnetic head 11, write operation is likely to be inhibited due to vibration of the magnetic head 11.

On the other hand, while the method of varying the maximum of the target velocity is effective for reducing power consumption, the same target velocity is used in the acceleration section until attainment of the maximum velocity and in the deceleration section from the maximum velocity until stoppage, and hence the manner of deceleration remains unchanged. Therefore the behavior of current variation during deceleration remains the same, with small effect of avoiding vibration due to mechanical resonance at the time of reaching the target track.

In general, it is not necessarily possible to perform data write once the magnetic head 11 reaches the target track 14T. Write operation can be performed only after the data sector 14A to be written with data comes under the magnetic head 11. Hence, even if the magnetic head 11 is rapidly moved, it may be necessary to wait for the data sector 14A to come under the magnetic head 11. Then, rapidly decelerating the magnetic head 11 tends to excite vibration of the magnetic head 11 when the magnetic head 11 is stopped at the target track 14T, and the magnetic head 11 may fail to cease vibrating until the data sector 14A comes. In this case, the data cannot be written until the disk 14 rotates another turn.

In contrast, according to this embodiment, the target velocity curve and the velocity feedback gain are independently made variable. That is, in addition to the maximum velocity, the rate of velocity change in the deceleration section is also varied. Then, as shown in FIG. 3, the time allowed for seek (allowed seek time T_{SE}) is found on the basis of position of the magnetic head 11 before motion, for example, the track where the magnetic head 11 resides at seek start time, and the target position of the magnetic head and position of a data sector, for example, the track and data sector to be written with data. The target velocity curve parameters and the velocity feedback gain are selected from a table prepared beforehand so that the head is moved to the target track within the above allowed time. Thus it is possible to smoothly seek the magnetic head by the time until the track to be written with data comes under the target position of the magnetic head without unnecessary rapid acceleration or deceleration of the magnetic head.

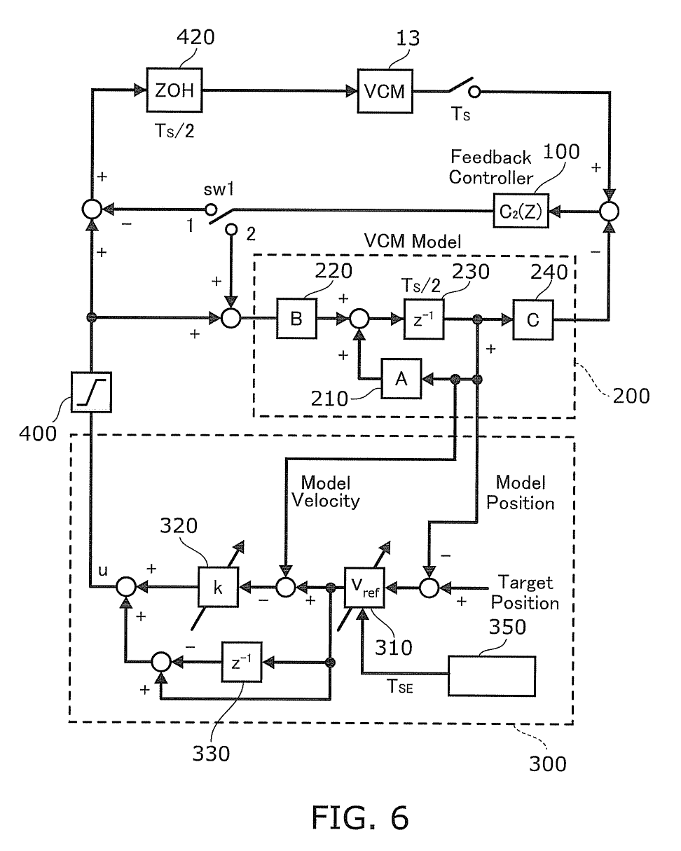

FIG. 6 is a block diagram illustrating a seek control system of the magnetic disk apparatus of this embodiment.

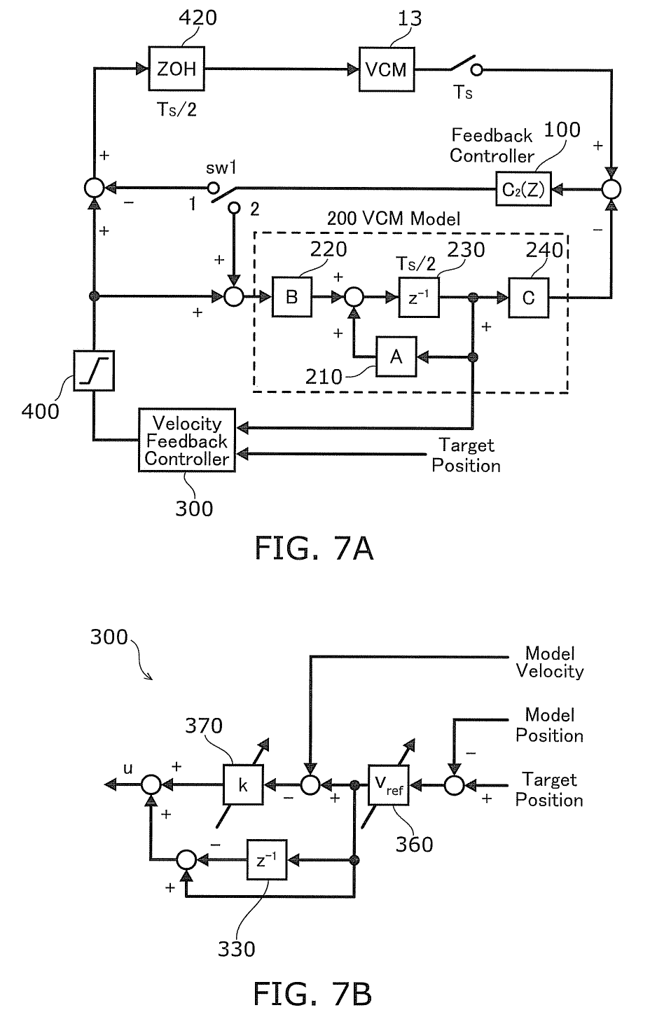

FIGS. 7A and 7B are block diagrams illustrating a seek control system of a magnetic disk apparatus of a comparative example.

In both of these seek control systems, the model control system 200 includes a combination of A matrix 210, B matrix 220, C matrix 240, which dictate the state equation, and a one-sample delay 230.

In the comparative example shown in FIG. 7, the velocity feedback controller 300 includes a target velocity curve determination unit 360 and a velocity feedback gain determination unit 370, which store a fixed target velocity curve vref and velocity feedback gain k, respectively. That is, the velocity feedback controller 300 performs velocity feedback on the basis of a target velocity curve having a constantly fixed variation of acceleration/deceleration and a fixed velocity feedback gain.

In contrast, in the seek control system of this embodiment shown in FIG. 6, the target velocity curve determination unit 310 and the velocity feedback gain determination unit 320 provided in the velocity feedback controller 300 store variable parameters. The time allowed for seek is found using the track where the magnetic head 11 resides at seek start time and the track and data sector to be written with data. The target velocity curve parameters and the velocity feedback gain are selected from a table prepared beforehand so that the magnetic head 11 gradually moves to the target track within this allowed time. Specifically, as shown in FIG. 3 for example, a target track number is outputted to a cache 350, and the time allowed for seek, T_{SE}, can be received from the cache 350.

The target velocity curve vref can be given by the following formula, for example:

$${v}_{ref} = \{ \begin{matrix}b \sqrt{x - c} - d \\ ax\end{matrix} \} \qquad ( 1 )$$

where x is the seek distance, that is the driving amount of the drive unit. In this case, the target velocity curve is expressed by a combination of a linear section defined by parameter a and a curved section defined by parameters b, c, and d. The linear section is followed when the distance x is on the smaller side of the junction between the linear section and the curved section, and the curved section is followed when the distance x is on the larger side of the junction.

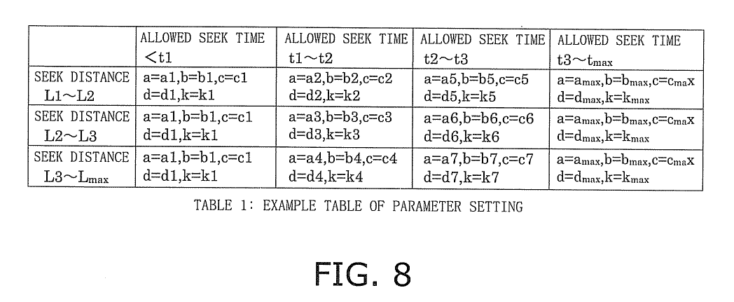

FIG. 8 conceptually illustrates a table of the parameter set stored in the target velocity curve determination unit 310 and the velocity feedback gain determination unit 320.

More specifically, the parameters a, b, c, and d of the target velocity curve and the velocity feedback gain k can be preset depending on the combination of seek distance x and allowed seek time T_{SE}. At seek start time, on the basis of the track where the magnetic head 11 resides at seek start time and the track and data sector to be written with data, the velocity feedback controller 300 determines the time allowed for seek (allowed seek time) T_{SE}, that is, the time until the data sector to be written with data comes under the target position of the magnetic head 11, and selects the parameters of the target velocity curve and the velocity feedback gain from the table of FIG. 8 so that the head gradually moves to the target track within this time.

As described later in detail with reference to examples, the parameters a, b, c, and d of the target velocity curve are preferably set so that the magnetic head can move a prescribed distance within a prescribed time with minimizing the occurrence of rapid deceleration. That is, the parameters a, b, c, and d are determined in the table of FIG. 8 so that the target velocity decreases as the allowed seek time increases. For example, the parameter a is preferably set to be smaller as the allowed seek time T_{SE} increases.

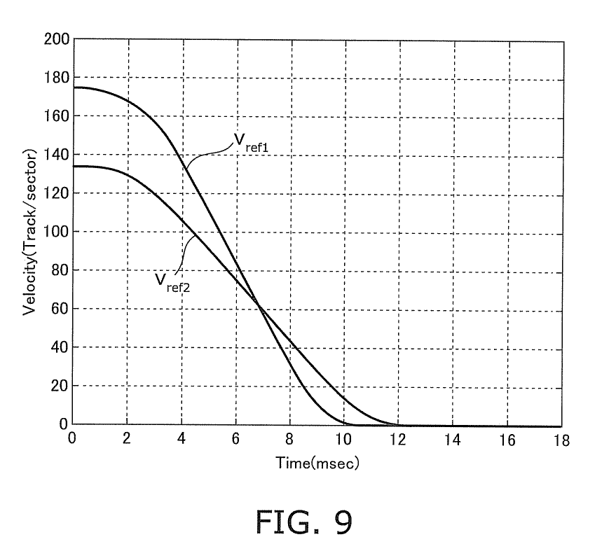

FIG. 9 is a graph illustrating the temporal variation of the target velocity.

In this example, the target velocity curve v_{ref1} causes the magnetic head 11 to move with high velocity and rapid deceleration and in a short time, whereas the target velocity curve v_{ref2} causes the magnetic head 11 to move with low velocity and gradual deceleration and in a longer time. In this embodiment, the rate of deceleration of the target velocity is thus varied. If any of these target velocity curves v_{ref1} and v_{ref2} can be used for moving the magnetic head 11 by a prescribed seek distance within a prescribed time, it is preferable to use v_{ref2}, which is associated with gradual deceleration. Thus it is possible to prevent rapid deceleration and to reduce vibration of the magnetic head 11.

On the other hand, typically, it is preferable that the feedback gain k be set to be larger for high target velocity, and to be smaller for low target velocity. For a high target velocity, the feedback gain needs to be increased to some extent for following the high target velocity. However, for a low target velocity, it is preferable that the feedback gain be also decreased to prevent rapid acceleration or deceleration.

In the following, simulation examples of the invention are described.

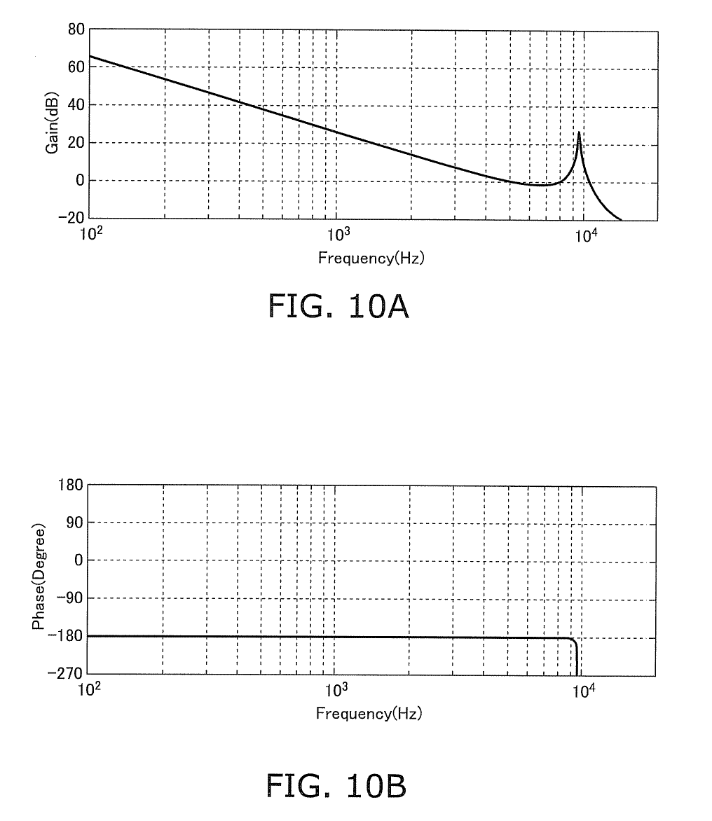

FIGS. 10A and 10B show graphs of the frequency characteristics of a controlled object in this example. More specifically, FIG. 10A shows gain from the control command of the seek control system to the magnetic head position, and FIG. 10B shows the frequency characteristics of the phase thereof.

The controlled object (VCM) used in the simulation of this example was provided with a mechanical resonance in the vicinity of 9.5 kHz. Double integral was used for the VCM model of the model control system 200 (see FIGS. 2 and 6). The sampling frequency was set to 10.08 kHz, and the calculation frequency of the model control system was set to 20.16 kHz.

As a first case, the target velocity curve expressed by formula (2) and the velocity feedback gain expressed by formula (3) were applied to this controlled object for seek operation. Formulas (2) and (3) are primarily intended to move the head to the target track as rapid as possible.

$$\begin{matrix}{v}_{ref} = \{ \begin{matrix}2.3975 \sqrt{x + 54.209} - 17.669 & x > 5 \\ 0.15576 x & x < 5\end{matrix} Track \text{/} Sector & ( 2 ) \\ k = \frac{1}{4} & ( 3 )\end{matrix}$$

Furthermore, as a second case, the target velocity curve expressed by formula (4) and the velocity feedback gain expressed by formula (5) were used for seek operation.

$$\begin{matrix}{v}_{ref} = \{ \begin{matrix}1.8224 \sqrt{x + 19.77} - 10.071 & x > 58 \\ 0.10344 x & x < 58\end{matrix} Track \text{/} Sector & ( 4 ) \\ k = \frac{1}{10} & ( 5 )\end{matrix}$$

These conditions are established on the assumption that an allowed seek time of 16 milliseconds is given. As compared with the first case, the second case is intended to move the head to the target track with lower velocity.

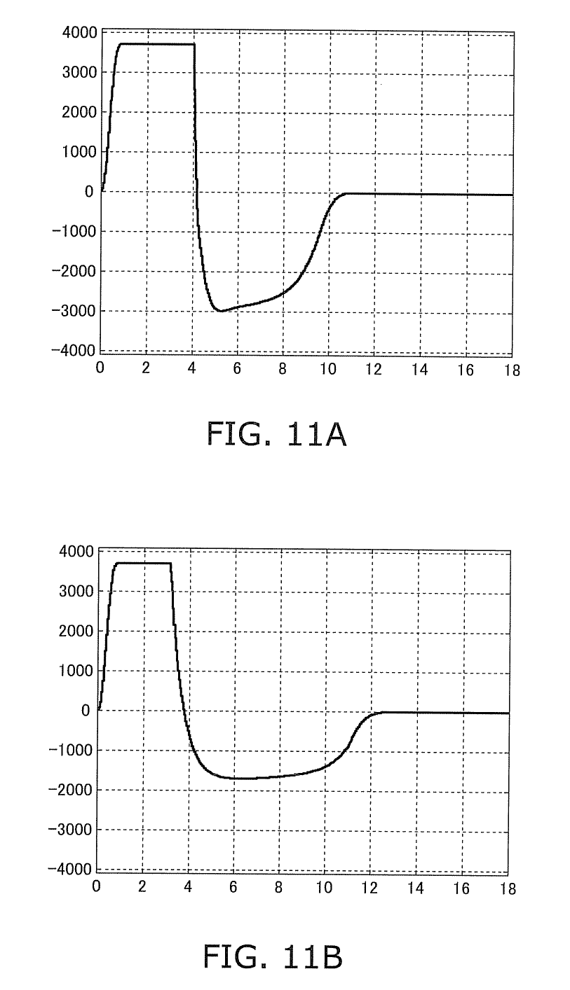

FIGS. 11A and 11B show graphs of control commands to the VCM. More specifically, FIGS. 11A and 11B show a control command for the first and second case, respectively. In these graphs, the horizontal axis represents time (in milliseconds), and the vertical axis represents the numerical value of a control command presented to the D/A converter 19 (see FIG. 1).

In the first case shown in FIG. 11A, the parameters a, b, and c of the target velocity curve are large, and the velocity feedback gain k is also large. Hence the command value rapidly decreases from the upper limit of +3700 to approximately −3000. That is, the VCM is subjected to rapid acceleration and deceleration. In contrast, in the second case shown in FIG. 11B, the decrease from the upper limit value is gradual, and the minimum is restricted to approximately −1700. That is, it turns out that the VCM is controlled more gradually.

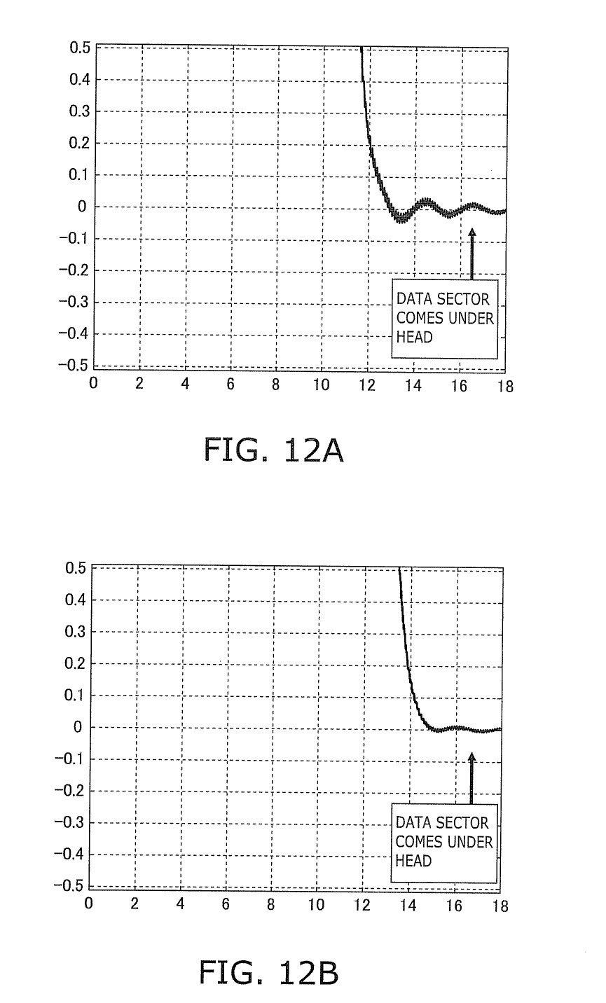

FIGS. 12A and 12B show graphs of response waveforms at the settling time of the VCM. More specifically, FIGS. 12A and 12B show a response waveform for the first and second case, respectively. In these graphs, the horizontal axis represents time (in milliseconds), and the vertical axis represents the number of remaining tracks from the current track to the target track.

The first case shown in FIG. 12A is based on a target velocity curve with high velocity and a large velocity feedback gain. Hence, when the data sector comes under the magnetic head 11, vibration still remains and data cannot be written. In this case, it is necessary to wait for another turn. In the case of this simulation, the number of revolutions is 5400 rpm. Hence the time required for data write adds 11 milliseconds or more to the seek time.

In contrast, in the second case shown in FIG. 12B, vibration due to mechanical resonance at the settling time is suppressed. Thus it is possible to write data immediately when the data sector to be written comes under the magnetic head 11.

As described above, according to this embodiment, the allowed seek time T_{SE} is calculated from the position of the magnetic head 11 before motion, and the target position of the magnetic head and position of a data sector and the parameters of the target velocity curve and the velocity feedback gain are varied on the basis of this allowed seek time T_{SE}. Thus data can be read and/or written immediately when the data sector comes under the head.

The embodiment of the invention has been described with reference to examples. However, the invention is not limited to the above examples. Two or more of the examples described above with reference to FIGS. 1 to 12 can be combined with each other as long as technically feasible, and such combinations are also encompassed within the scope of the invention.

Furthermore, the target velocity curve, for example, is not limited to the combination of a linear section and a curved section as expressed by formula (1). Instead of these linear and curved section, the target velocity curve may be any combination of two or more linear and curved sections expressed by other formulas, or may be expressed by a single curve.

Other elements such as the magnetic head, arm, voice coil motor, disk, MPU, D/A converter, servo data processing circuit, position error feedback control system, model control system, velocity feedback controller, target velocity curve determination unit, and velocity feedback gain determination unit are not limited to those in the above examples. Any modifications appropriately made by those skilled in the art are also encompassed within the scope of the invention as long as they include the features of the invention. That is, the invention is not limited to the examples, but can be practiced in various modifications without departing from the spirit thereof, and these modifications are all encompassed within the scope of the invention.

1. A magnetic disk apparatus comprising:
a driving unit configured to move a magnetic head operative for magnetic recording/reproduction of information on a magnetic disk;
a position error feedback control system configured to perform feedback control of the driving unit based on difference between target track position and detected position of the magnetic head; and
a velocity control system configured to vary a target velocity curve based on position of the magnetic head before motion, the target track position of the magnetic head, and position of a data sector to be subjected to recording/reproduction, for using a control mathematical model of the driving unit to control the driving unit so that velocity of the driving unit follows the target velocity curve.

2. The apparatus according to claim 1, wherein the velocity control system varies parameters defining the target velocity curve based on the position of the magnetic head before motion, the target track position of the magnetic head, and the position of the data sector to be subjected to recording/reproduction.

3. The apparatus according to claim 1, wherein the velocity control system controls the magnetic head so that the magnetic head gradually decelerates when there is a long time until the data sector comes under the target track position of the magnetic head.

4. The apparatus according to claim 1, wherein the velocity control system allows a velocity feedback gain of the driving unit to be varied.

5. The apparatus according to claim 4, wherein the velocity control system decreases the feedback gain when there is a long time until the data sector comes under the target track position of the magnetic head.

6. The apparatus according to claim 1, wherein
relationship between a driving amount x of the driving unit and a target velocity v of the driving unit includes approximation given by v=ax, and
the velocity control system decreases constant a when there is a long time until the data sector comes under the target track position of the magnetic head.

7. The apparatus according to claim 1, wherein the target velocity curve and a velocity feedback gain of the driving unit are independently variable.

8. The apparatus according to claim 1, wherein the velocity control system stores parameters defining the target velocity curve and velocity feedback gains being set corresponding to a combination of a time until the data sector comes under the target track position of the magnetic head and a driving amount of the driving unit.

9. The apparatus according to claim 8, wherein the velocity control system selects the parameters defining the target velocity curve from the stored parameters so that the magnetic head is moved to the target track position of the magnetic head within the time.

10. The apparatus according to claim 8, wherein the velocity control system selects the velocity feedback gain from the stored velocity feedback gains so that the magnetic head is moved to the target track position of the magnetic head within the time.

11. A magnetic disk apparatus comprising:
a driving unit configured to move a magnetic head operative for magnetic recording/reproduction of information on a magnetic disk; and
a velocity control system configured to control the driving unit,
the velocity control system varying a target velocity curve based on a time until a data sector comes under a target track position of the magnetic head, the time being found from a position of the magnetic head before motion, the target track position of the magnetic head, and a position of a data sector to be subjected to recording/reproduction.

12. The apparatus according to claim 11, wherein the velocity control system stores parameters defining the target velocity curve and velocity feedback gains corresponding to a combination of the time and a driving amount of the driving unit.

13. The apparatus according to claim 12, wherein the velocity control system selects the parameters defining the target velocity curve from the stored parameters so that the magnetic head is moved to the target track position of the magnetic head within the time.

14. The apparatus according to claim 12, wherein the velocity control system selects the velocity feedback gain from the stored velocity feedback gains so that the magnetic head is moved to the target track position of the magnetic head within the time.

15. A method for controlling a magnetic head of a magnetic disk apparatus, comprising:
performing feedback control of a driving unit based on difference between target track position and detected position of the magnetic head; and, concurrently,
varying a target velocity curve based on position of the magnetic head before motion, the target track position of the magnetic head, and position of a data sector to be subjected to recording/reproduction, and controlling the driving unit by using a control mathematical model of the driving unit so that a velocity of the driving unit follows the target velocity curve.

16. The method according to claim 15, wherein parameters defining the target velocity curve are varied based on the position of the magnetic head before motion, the target track position of the magnetic head, and the position of the data sector to be subjected to recording/reproduction.

17. The method according to claim 15, wherein the magnetic head is controlled so that the magnetic head gradually decelerates when there is a long time until the data sector comes under the target track position of the magnetic head.

18. The method according to claim 15, wherein a velocity feedback gain of the driving unit is made variable.

19. The method according to claim 15, wherein
relationship between driving amount x of the driving unit and the target velocity v of the driving unit includes approximation given by v=ax, and
constant a is decreased when there is a long time until the data sector comes under the target track position of the magnetic head.

20. The method according to claim 18, wherein the feedback gain is decreased when there is a long time until the data sector comes under the target track position of the magnetic head.
